(19) United States
(12) Patent Application Publication
(10) Pub. No.: US 2025/0097161 A1
(43) Pub. Date: Mar. 20, 2025

(54) SIGNAL TRANSFER SYSTEM AND SIGNAL TRANSFER METHOD

(71) Applicant: NIPPON TELEGRAPH AND TELEPHONE CORPORATION, Tokyo (JP)

(72) Inventors: Kenji MIYAMOTO, Musashino-shi (JP); Yoshihito SAKAI, Musashino-shi (JP); Tatsuya SHIMADA, Musashino-shi (JP)

(73) Assignee: NIPPON TELEGRAPH AND TELEPHONE CORPORATION, Tokyo (JP)

(21) Appl. No.: 18/727,916

(22) PCT Filed: Feb. 25, 2022
(86) PCT No.: PCT/JP2022/007921

§ 371 Date: Jul. 10, 2024

(51) Int. Cl. H04L 47/283; H04W 28/06

(52) U.S. Cl. CPC H04L 47/283; H04W 28/06

(57) ABSTRACT

According to an aspect of the present invention, there is provided a signal transfer system that transfers a signal from one communication device to another communication device, the signal transfer system including an information acquisition unit that acquires network transfer information that is information regarding a traffic flow for each traffic flow from the one communication device to the other communication device; and a communication control unit that executes an adjustment process that is a process of reducing a waiting time for a frame on the basis of the network transfer information acquired by the information acquisition unit.

### TECHNICAL FIELD

The present invention relates to a signal transfer system and a signal transfer method.

### BACKGROUND ART

In signal transmission in a conventional mobile communication system, in a case where a base station and a wireless terminal exchange signal, time division duplex (TDD) in which a downlink signal and an uplink signal are alternately transmitted in a time domain is used, and at that time, transmission and reception of signals are performed in units of radio transmission frames called a transport block.

### CITATION LIST

### Non Patent Literature

Non Patent Literature 1: 3GPP TS 38.300 V16.7.0″, 3GPP, 2021.
Non Patent Literature 2: 3GPP TS 38.214 V16.7.0″, 3GPP, 2021.

### SUMMARY OF INVENTION

### Technical Problem

However, jitter may occur due to a downlink transmission waiting time during uplink transmission in TDD or a waiting time for forming a transport block in a case where a size of the transport block is larger than a frame size received from an upper network. This may occur even if transmission to the base station is performed in a state in which frame transmission intervals are aligned in the upper network and jitter is small in each downlink traffic flow.

As a result, end-to-end jitter may increase due to jitter in a radio transmission section. Note that such circumstances are common not only in a mobile communication system but also in communication between communication devices.

In view of the above circumstances, an object of the present invention is to curb an increase in jitter.

### Solution to Problem

According to an aspect of the present invention, there is provided a signal transfer system that transfers a signal from one communication device to another communication device, the signal transfer system including an information acquisition unit that acquires network transfer information that is information regarding a traffic flow for each traffic flow from the one communication device to the other communication device; and a communication control unit that executes an adjustment process that is a process of reducing a waiting time for a frame on the basis of the network transfer information acquired by the information acquisition unit.

According to another aspect of the present invention, there is provided a signal transfer method of transferring a signal from one communication device to another communication device, the signal transfer method including an information acquisition step of acquiring network transfer information that is information regarding a traffic flow for each traffic flow from the one communication device to the other communication device; and a communication control step of executing an adjustment process that is a process of reducing a waiting time for a frame on the basis of the network transfer information acquired in the information acquisition step.

### Advantageous Effects of Invention

According to the present invention, it is possible to curb an increase in jitter.

### BRIEF DESCRIPTION OF DRAWINGS

FIG. 1 is an explanatory diagram for describing an outline of a signal transfer system according to an embodiment.

FIG. 2 is a first explanatory diagram for describing an effect of an adjustment process in the embodiment.

FIG. 3 is a second explanatory diagram for describing an effect of an adjustment process in the embodiment.

FIG. 4 is a diagram illustrating a first application example of the signal transfer system according to the embodiment.

FIG. 5 is a flowchart illustrating an example of a flow of processing executed by the signal transfer system according to the first application example in the embodiment.

FIG. 6 is a diagram illustrating a second application example of the signal transfer system according to the embodiment.

FIG. 7 is a flowchart illustrating an example of a flow of processing executed by the signal transfer system according to the second application example in the embodiment.

FIG. 8 is a diagram illustrating a third application example of the signal transfer system according to the embodiment.

FIG. 9 is a flowchart illustrating an example of a flow of processing executed by the signal transfer system according to the third application example in the embodiment.

FIG. 10 is a diagram illustrating a fourth application example of the signal transfer system according to the embodiment.

FIG. 11 is a flowchart illustrating an example of a flow of processing executed by the signal transfer system according to the fourth application example in the embodiment.

FIG. 12 is a diagram illustrating an example of a hardware configuration of a first transfer device according to the embodiment.

FIG. 13 is a diagram illustrating an example of a configuration of a control unit included in the first transfer device according to the embodiment.

FIG. 14 is a diagram illustrating an example of a configuration of a second transfer device according to the embodiment.

FIG. 15 is a diagram illustrating an example of a hardware configuration of a first transfer device controller according to the embodiment.

FIG. 16 is a diagram illustrating an example of a configuration of a control unit included in the first transfer device controller in the embodiment.

FIG. 17 is a diagram illustrating an example of a configuration of a second transfer device controller according to the embodiment.

FIG. 18 is a diagram illustrating an example of a hardware configuration of a first base station in the embodiment.

FIG. 19 is a diagram illustrating an example of a configuration of a control unit included in the first base station in the embodiment.

FIG. 20 is a diagram illustrating an example of a configuration of a second base station in the embodiment.

FIG. 21 is a diagram illustrating an example of a configuration of a control unit included in the second base station in the embodiment.

FIG. 22 is a diagram illustrating an example of a hardware configuration of a first distributed station in the embodiment.

FIG. 23 is a diagram illustrating an example of a configuration of a control unit included in the first distributed station in the embodiment.

FIG. 24 is a diagram illustrating an example of a configuration of a second distributed station in the embodiment.

FIG. 25 is a diagram illustrating an example of a configuration of a control unit included in the second distributed station in the embodiment.

FIG. 26 is a diagram illustrating an example of a hardware configuration of a communication device according to the embodiment.

FIG. 27 is a diagram illustrating an example of a configuration of a control unit included in the communication device according to the embodiment.

FIG. 28 is a diagram for describing an example of a configuration of a signal transfer system in a modification example.

FIG. 29 is a diagram illustrating an example of a hardware configuration of a wireless controller in the modification example.

FIG. 30 is a diagram illustrating an example of a configuration of a control unit included in the wireless controller according to the modification example.

### DESCRIPTION OF EMBODIMENTS

### Embodiment

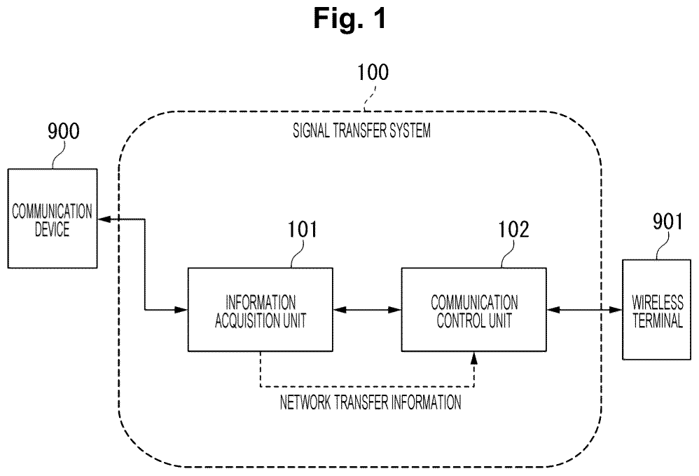

FIG. 1 is an explanatory diagram illustrating an outline of a signal transfer system 100 according to an embodiment. The signal transfer system 100 is a system that transfers a signal from one communication device to the other communication device. The signal transfer system 100 includes, for example, a transfer device, a base station, and a control device of the transfer device, and transfers a signal from a server to a wireless terminal and transfers a signal from the wireless terminal to the server. The signal transfer system 100 includes, for example, a transfer device, a distributed station, and a control device of the transfer device, and transfers a signal from a central station to a wireless terminal and transfers a signal from the wireless terminal to the central station. An application example of such a signal transfer system 100 will be described in detail later, and first, an outline of the signal transfer system 100 will be described.

The signal transfer system 100 includes an information acquisition unit 101 and a communication control unit 102. The information acquisition unit 101 acquires network transfer information for each traffic flow from one communication device to the other communication device. The network transfer information is information regarding a traffic flow. The information regarding the traffic flow indicates, for example, a frame size and a transmission interval. Therefore, the network transfer information includes, for example, information indicating a frame size and a transmission interval. The frame size and the transmission interval indicated by the information indicating a frame size and a transmission interval are, for example, a downlink frame size and a transmission interval.

The information regarding a traffic flow may indicate, for example, a transmission rate or a destination address. Therefore, the network transfer information may include, for example, information indicating a transmission rate or information indicating a destination address.

One communication device is, for example, the above-described server, and in this case, the other communication device is, for example, a wireless terminal. In a case where one communication device is, for example, a wireless terminal, the other communication device is, for example, the above-described server. In the case of such communication between the server and the wireless terminal, a size of a downlink frame indicated by the network transfer information is, for example, a size of a frame from the server to the wireless terminal. That is, in such a case, the downlink indicates a direction from the server to the wireless terminal in a propagation direction of a signal.

One communication device is, for example, the above-described central station, and in this case, the other communication device is, for example, a wireless terminal. In a case where one communication device is, for example, a wireless terminal, the other communication device is, for example, the above-described central station. In the case of such communication between the central station and the wireless terminal, a size of a downlink frame indicated by the network transfer information is, for example, a size of a frame from the central station to the wireless terminal. That is, in such a case, the downlink indicates a direction from the central station toward the wireless terminal in a propagation direction of a signal.

A communication device 900 in FIG. 1 is an example of one communication device, and a wireless terminal 901 in FIG. 1 is an example of the other communication device. Therefore, the communication device 900 may be, for example, a server, or may be, for example, a central station.

The communication control unit 102 executes an adjustment process on the basis of the network transfer information obtained by the information acquisition unit 101. The adjustment process is a process of reducing a waiting time until a frame is transmitted according to a predetermined rule determined in advance on the basis of the network transfer information.

The process of reducing the waiting time until a frame is transmitted is, for example, a process of adjusting a frame transmission timing in time division duplex (TDD) according to a predetermined rule set in advance (hereinafter, referred to as a “TDD timing adjustment process”). The frame transmission timing is a timing at which a frame is transmitted. The process of reducing a waiting time until a frame is transmitted may be, for example, a process of adjusting a transport block size (TBS) according to a predetermined rule set in advance (hereinafter, referred to as a “TBS adjustment process”).

The adjustment process may be, for example, a process of adjusting both a frame transmission timing in TDD and a TBS according to a predetermined rule set in advance. Therefore, the adjustment process is, for example, a process of performing one or both of the TDD timing adjustment process and the TBS adjustment process.

A waiting time until a frame is transmitted in the adjustment process is, for example, a waiting time for a downlink transmission frame. The downlink transmission frame is a frame propagating in the downlink direction and is a frame transmitted to a transmission destination such as the wireless terminal 901. Therefore, in a case where a transmission destination is the wireless terminal 901, the downlink transmission frame is a frame transmitted from one communication device such as a server or a central station to the wireless terminal 901.

In a case where a waiting time until a frame is transmitted is a waiting time for a downlink transmission frame, the frame transmission timing is, for example, a downlink transmission timing. The downlink transmission timing is a timing at which a downlink transmission frame is transmitted.

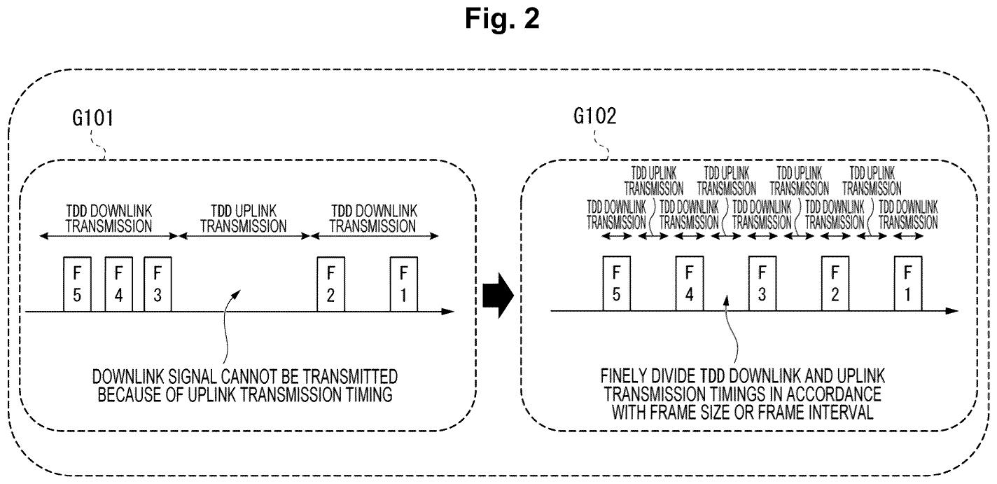

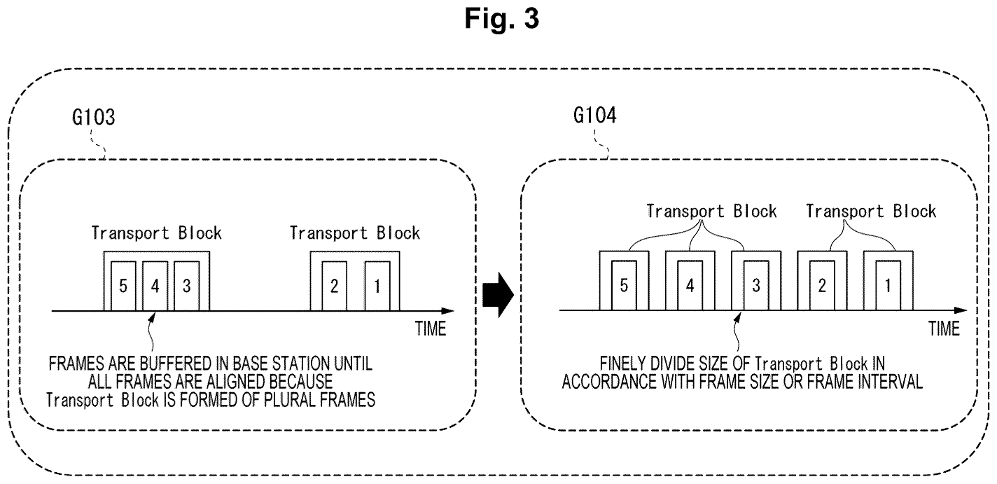

Effects obtained by the adjustment process will be described with reference to FIGS. 2 and 3. In order to simplify the description below, effects of the adjustment process will be described by using a traffic flow from the base station toward the wireless terminal as an example. FIG. 2 is a first explanatory diagram for describing an effect of the adjustment process in the embodiment. More specifically, FIG. 2 is a diagram for describing an effect of the TDD timing adjustment process in the embodiment.

An image G101 in FIG. 2 illustrates an example of a state of a signal transmitted from the base station to the wireless terminal in a case where the adjustment process is not performed. More specifically, the image G101 illustrates an example of a state of signal transmission in a case where the adjustment process is not performed by using five frames F1 to F5. In the image G101, a period between the frame F2 and the frame F3 is an uplink transmission timing in TDD.

In a case where the adjustment process is not performed, a downlink signal cannot be transmitted at this timing. As a result, as illustrated in the image G101, a time interval between the frame F1 and the frame F2, a time interval between the frame F2 and the frame F3, and a time interval between the frame F3 and the frame F4 are non-uniform. The non-uniformity of the frame interval increases jitter.

An image G102 in FIG. 2 illustrates an example of a state of signal transmission from the base station to the wireless terminal in a case where the TDD timing adjustment process is performed. More specifically, the image G102 illustrates an example of a state of signal transmission in a case where the TDD timing adjustment process is performed by using five frames F1 to F5. As described above, the TDD timing adjustment process is a process of performing adjustment in order to reduce a waiting time for a frame.

As an example of the TDD timing adjustment process, the image G102 illustrates an example of a result of performing a process of more finely dividing downlink and uplink transmission timings in TDD than in the case of the image G101 on the basis of the frame size and the frame interval. Note that finely dividing the transmission timing indicates, for example, setting a time interval of downlink transmission in TDD to an interval according to a downlink frame size and setting a time interval of uplink transmission in TDD to an interval according to a transmission interval of a downlink frame. Thus, in the example of the image G102, the frame intervals are uniform. Therefore, in the example of the image G102, jitter is reduced.

FIG. 3 is a second explanatory diagram for describing an effect of the adjustment process in the embodiment. More specifically, FIG. 3 is a diagram for describing an effect of the TBS adjustment process in the embodiment.

An image G103 of FIG. 3 illustrates an example of a state of signal transmission from the base station to the wireless terminal in a case where the adjustment process is not performed. More specifically, the image G103 illustrates an example of a state of signal transmission in a case where the adjustment process is not performed by using five frames 1 to 5. In the example of the image G103, the frames 1 and 2 form one transport block.

In the example of the image G103, the frames 3 to 5 form another transport block different from the frames 1 and 2. Respective transport blocks have different sizes because the number of frames included therein is different. In the example of the image G103, since the transport block is formed by a plurality of frames, a buffer is generated in the base station until all the frames are completed. As illustrated in the image G103, the frame intervals are not uniform in the example of the image G103. Therefore, in the example of the image G103, jitter increases.

An image G104 in FIG. 3 illustrates an example of a state of signal transmission from the base station to the wireless terminal in a case where the TBS adjustment process is performed. More specifically, the image G104 illustrates an example of a state of signal transmission in a case where the TBS adjustment process is performed by using five frames 1 to 5. The image G104 illustrates an example of a result of performing, as the TBS adjustment process, a process of more finely dividing a size of a transport block than in the case of the image G103 on the basis of a frame size and a frame interval. As a result, in the example of the image G104, each of the frames 1 to 5 forms one transport block. Therefore, in the example of the image G104, the frame intervals are uniform. Thus, in the example of the image G104, an increase in jitter is curbed.

As described above, by executing the adjustment process, an increase in jitter is curbed.

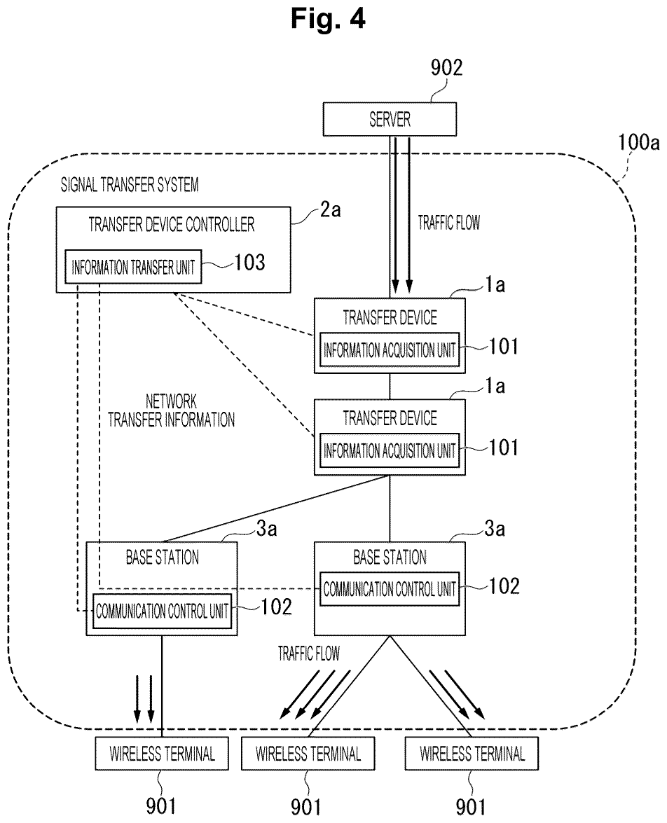

FIG. 4 is a diagram illustrating a first application example of the signal transfer system 100 in the embodiment. Hereinafter, the signal transfer system 100 in the first application example will be referred to as a signal transfer system 100a. The signal transfer system 100a transfers a signal from the server 902 to the wireless terminal 901 and transfers a signal from the wireless terminal 901 to the server 902. The server 902 is an example of the communication device 900. The signal transfer system 100a includes one or a plurality of transfer devices 1a, a transfer device controller 2a, and one or a plurality of base stations 3a. Both the server 902 and the wireless terminal 901 are devices that transmit and receive signals.

The transfer device la transfers a signal transmitted from a transfer source device to a transfer destination. The transfer device controller 2a controls an operation of each transfer device 1a included in the signal transfer system 100a. The transfer device controller 2a determines, for example, a destination to which each transfer device 1a transfers a signal. The base station 3a is a base station that communicates with the wireless terminal 901. The base station 3a transmits the signal transferred from the transfer device 1a to the wireless terminal 901 through communication with the wireless terminal 901, and transfers the signal received from the wireless terminal 901 to the transfer device la that is a transfer destination.

Each transfer device 1a includes an information acquisition unit 101. The information acquisition unit 101 included in the transfer device 1a acquires network transfer information on the basis of the signal received by the transfer device 1a.

The transfer device controller 2a includes an information transfer unit 103. The information transfer unit 103 acquires the network transfer information acquired by each information acquisition unit 101. The information transfer unit 103 transfers the acquired network transfer information to a predetermined transfer destination such as the communication control unit 102.

Each base station 3a includes a communication control unit 102. The communication control unit 102 included in the base station 3a acquires the network transfer information acquired by the information transfer unit 103. The communication control unit 102 included in the base station 3a performs an adjustment process on the basis of the acquired network transfer information.

Note that the base station 3a may be, for example, a Wi-Fi (registered trademark) access point. The signal transfer system 100 is not necessarily applied to a mobile communication system, and may be applied to a wireless communication system other than the mobile communication system.

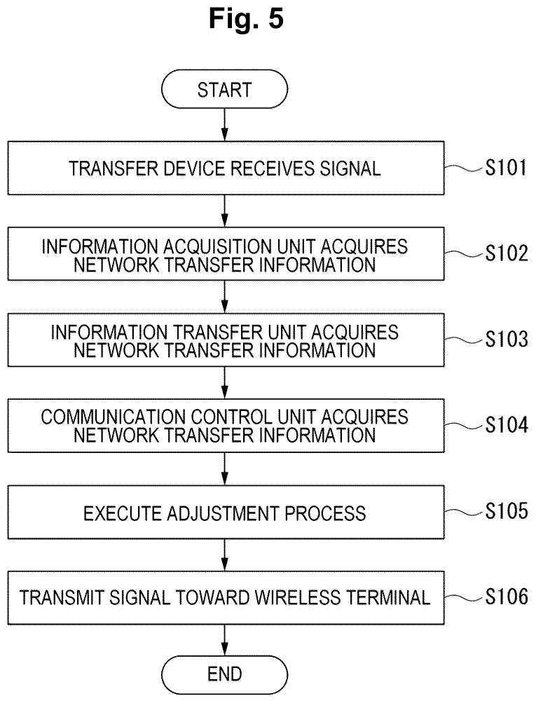

FIG. 5 is a flowchart illustrating an example of a flow of processing executed by the signal transfer system 100a according to the embodiment. More specifically, an example of a flow of processing executed by the signal transfer system 100a in a case where a signal is transmitted from the server 902 to the wireless terminal 901 will be described. In the signal transfer system 100a, the processing illustrated in FIG. 5 is repeatedly performed.

The transfer device 1a receives a signal transmitted from the server 902 (step S101). The information acquisition unit 101 included in the transfer device 1a acquires network transfer information on the basis of the received signal (step S102). The information transfer unit 103 acquires the network transfer information acquired by the information acquisition unit 101 (step S103). Next, the communication control unit 102 included in the base station 3a acquires the network transfer information acquired by the information transfer unit 103 (step S104).

The communication control unit 102 executes an adjustment process on the basis of the network transfer information (step S105). The communication control unit 102 transmits a signal in which a transmission timing or a transport block size is adjusted to the wireless terminal 901 (step S106).

In the example in FIG. 5, since the adjustment process is executed in step S105, an increase in jitter is curbed in the processing executed by the base station 3a in step S106.

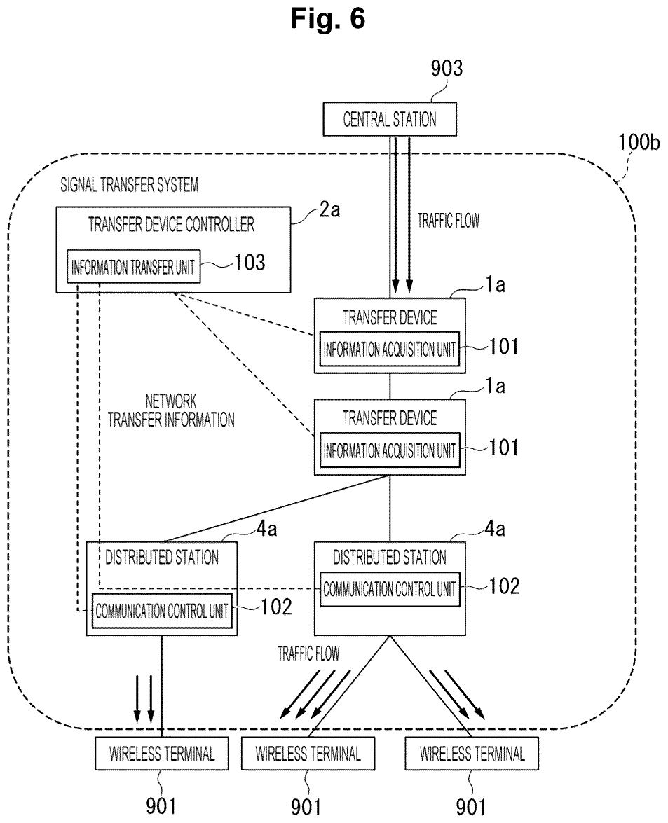

FIG. 6 is a diagram illustrating a second application example of the signal transfer system 100 according to the embodiment. Hereinafter, the signal transfer system 100 in the second application example will be referred to as a signal transfer system 100b. The signal transfer system 100b transfers a signal from the central station 903 to the wireless terminal 901 and transfers a signal from the wireless terminal 901 to the central station 903. The central station 903 is an example of the communication device 900. The signal transfer system 100b is different from the signal transfer system 100a in including a distributed station 4a instead of the base station 3a. The central station 903 is a central station that transmits and receives signals.

The distributed station 4a is a distributed station that communicates with the wireless terminal 901. The distributed station 4a transmits the signal transferred from the transfer device 1a to the wireless terminal 901 through communication with the wireless terminal 901, and thus transfers the signal received from the wireless terminal 901 to the transfer device 1a that is a transfer destination.

Each distributed station 4a includes a communication control unit 102. The communication control unit 102 included in the distributed station 4a acquires the network transfer information acquired by the information transfer unit 103. The communication control unit 102 included in the distributed station 4a performs an adjustment process on the basis of the acquired network transfer information.

Note that the central station and the distributed station in the example in FIG. 6 are, for example, a central unit (CU) and a distributed unit (DU) in a mobile communication system. The transfer device la in the example in FIG. 6 is installed in a section called mobile midhaul (MMH), for example.

The central station may be a DU, and the distributed station may be a radio unit (RU). In such a case, the transfer device 1a may be installed in a section called mobile fronthaul (MFH), for example.

The central station may also be a Wi-Fi controller, and the distributed station may be a Wi-Fi access point. The signal transfer system 100 is not necessarily applied to a mobile communication system, and may be applied to a wireless communication system other than the mobile communication system.

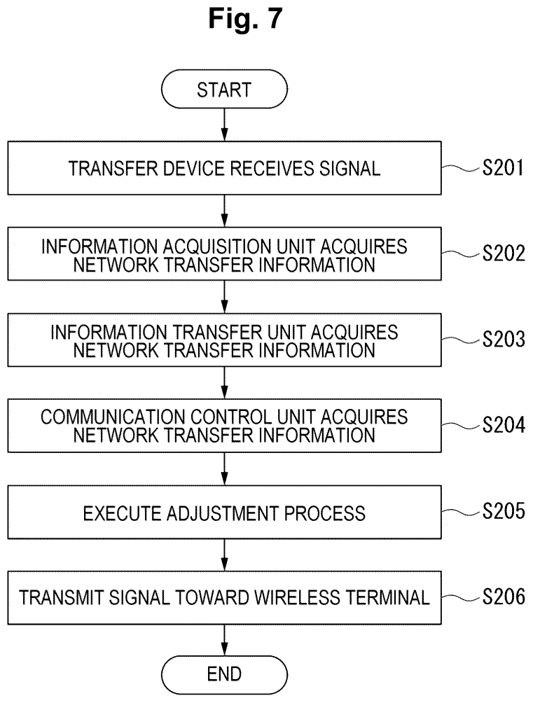

FIG. 7 is a flowchart illustrating an example of a flow of processing executed by the signal transfer system 100b according to the embodiment. More specifically, an example of a flow of processing executed by the signal transfer system 100b in a case where a signal is transmitted from the central station 903 to the wireless terminal 901 will be described. In the signal transfer system 100b, the processing illustrated in FIG. 7 is repeatedly performed.

The transfer device 1a receives a signal transmitted from the central station 903 (step S201). The information acquisition unit 101 included in the transfer device 1a acquires network transfer information on the basis of the received signal (step S202). The information transfer unit 103 acquires the network transfer information acquired by the information acquisition unit 101 (step S203). Next, the communication control unit 102 included in the distributed station 4a acquires the network transfer information acquired by the information transfer unit 103 (step S204). The communication control unit 102 executes an adjustment process on the basis of the network transfer information (step S205).

The communication control unit 102 transmits a signal in which a transmission timing or a transport block size is adjusted to the wireless terminal 901 (step S206).

In the example in FIG. 7, since the adjustment process is executed in step S205, an increase in jitter is curbed in the processing executed by the distributed station 4a in step S206.

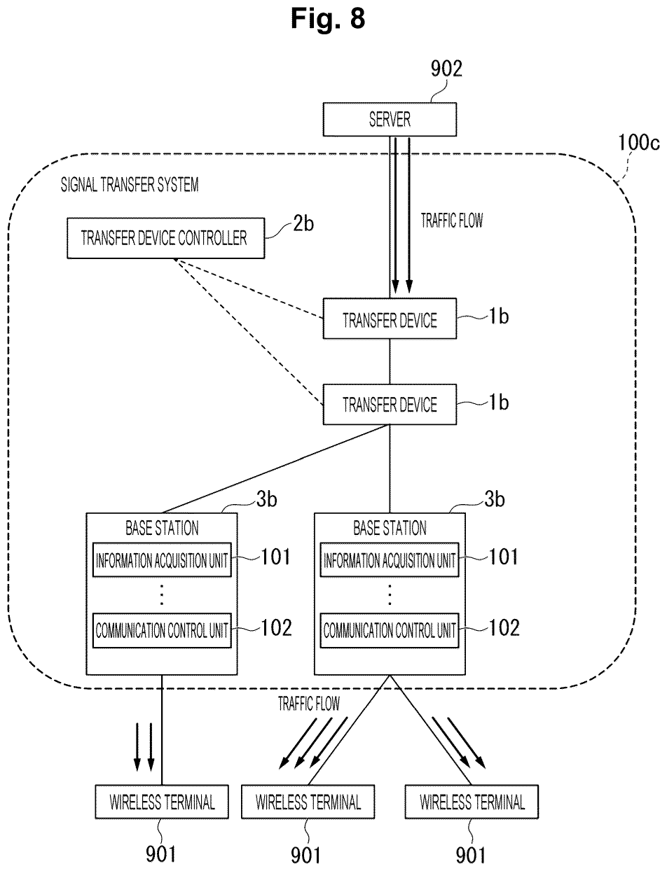

FIG. 8 is a diagram illustrating a third application example of the signal transfer system 100 according to the embodiment. Hereinafter, the signal transfer system 100 in the third application example will be referred to as a signal transfer system 100c. The signal transfer system 100c transfers a signal from the server 902 to the wireless terminal 901 and transfers a signal from the wireless terminal 901 to the server 902. The signal transfer system 100c includes one or a plurality of transfer devices 1b, a transfer device controller 2b, and one or a plurality of base stations 3b.

The transfer device 1b is different from the transfer device 1a in not including the information acquisition unit 101. The transfer device controller 2b is different from the transfer device controller 2a in not including the information transfer unit 103.

The base station 3b is a base station that communicates with the wireless terminal 901. The base station 3b transmits a signal transferred from the transfer device 1b to the wireless terminal 901 through communication with the wireless terminal 901, and transfers a signal received from the wireless terminal 901 to the transfer device 1b that is a transfer destination.

Each base station 3b includes an information acquisition unit 101 and a communication control unit 102. That is, the base station 3b is different from the base station 3a in including the information acquisition unit 101. The information acquisition unit 101 included in the base station 3b acquires the network transfer information on the basis of the signal received by the base station 3b.

The communication control unit 102 included in the base station 3b acquires the network transfer information acquired by the information acquisition unit 101. The communication control unit 102 included in the base station 3b performs an adjustment process on the basis of the acquired network transfer information.

Note that the base station 3b may be, for example, a Wi-Fi access point.

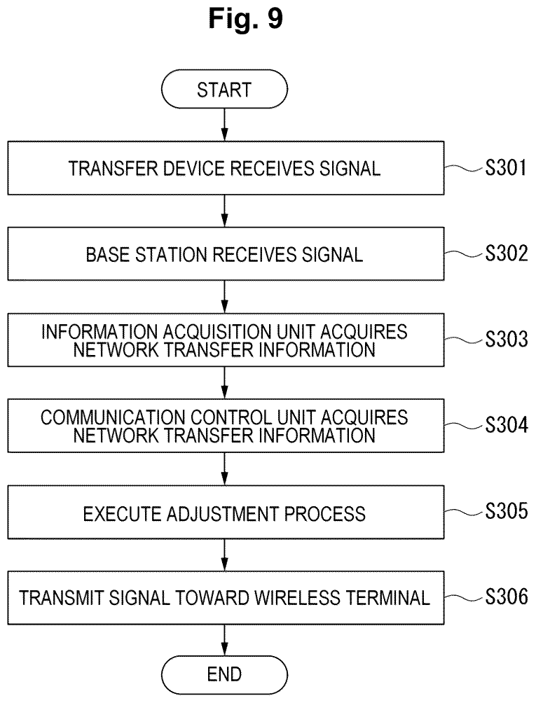

FIG. 9 is a flowchart illustrating an example of a flow of processing executed by the signal transfer system 100c according to the embodiment. More specifically, an example of a flow of processing executed by the signal transfer system 100c in a case where a signal is transmitted from the server 902 to the wireless terminal 901 will be described. In the signal transfer system 100c, the processing illustrated in FIG. 9 is repeatedly performed.

The transfer device 1b receives a signal transmitted from the server 902 (step S301). The signal acquired by the transfer device 1b in step S301 reaches the base station 3b via 0 or more transfer devices 1b. That is, the base station 3b receives the signal (step S302). The information acquisition unit 101 included in the base station 3b acquires network transfer information on the basis of the received signal (step S303). Next, the communication control unit 102 included in the base station 3b acquires the network transfer information acquired by the information acquisition unit 101 (step S304). The communication control unit 102 executes an adjustment process on the basis of the network transfer information (step S305). The communication control unit 102 transmits a signal in which a transmission timing or a transport block size is subjected to the adjustment process to the wireless terminal 901 (step S306).

In the example in FIG. 9, since the adjustment process is executed in step S305, an increase in jitter is curbed in the processing executed by the base station 3b in step S306.

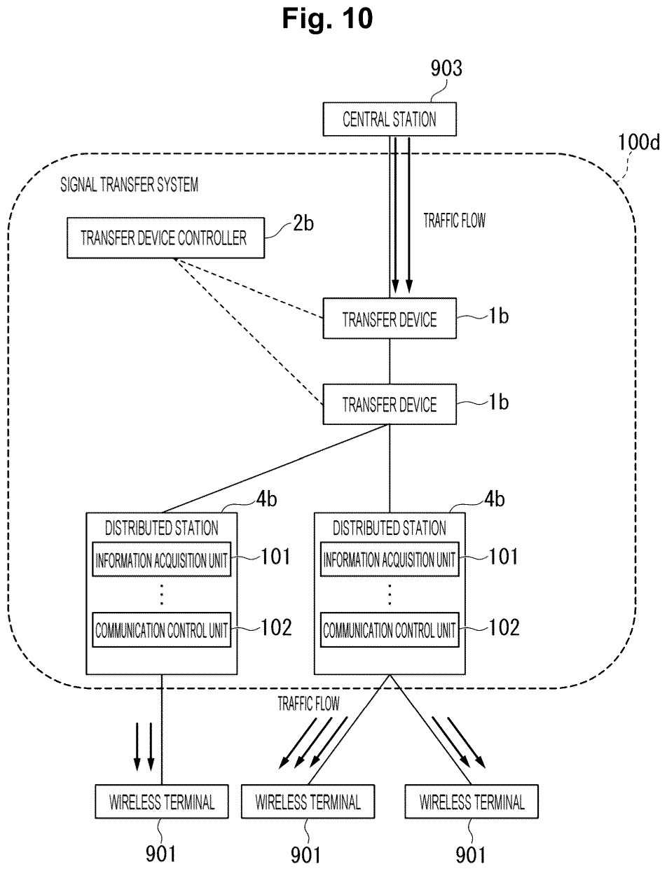

FIG. 10 is a diagram illustrating a fourth application example of the signal transfer system 100 according to the embodiment. Hereinafter, the signal transfer system 100 in the fourth application example will be referred to as a signal transfer system 100d. The signal transfer system 100d transfers a signal from the central station 903 to the wireless terminal 901 and transfers a signal from the wireless terminal 901 to the central station 903. The signal transfer system 100d is different from the signal transfer system 100c in including a distributed station 4b instead of the base station 3b.

The distributed station 4b is a distributed station that communicates with the wireless terminal 901. The distributed station 4b transmits the signal transferred from the transfer device 1b to the wireless terminal 901 through communication with the wireless terminal 901, and transfers the signal received from the wireless terminal 901 to the transfer device 1b that is a transfer destination.

Each distributed station 4b includes an information acquisition unit 101 and a communication control unit 102. That is, the distributed station 4b is different from the distributed station 4a in including the information acquisition unit 101. The information acquisition unit 101 included in the distributed station 4b acquires network transfer information on the basis of the signal received by the distributed station 4b.

The communication control unit 102 included in the distributed station 4b acquires the network transfer information acquired by the information acquisition unit 101. The communication control unit 102 included in the distributed station 4b performs an adjustment process on the basis of the acquired network transfer information.

Note that the central station and the distributed station in the example in FIG. 10 are, for example, a CU and a DU in the mobile communication system, similarly to the example in FIG. 6. The transfer device 1b in the example in FIG. 10 is installed in a section called MMH, for example.

Also in the example in FIG. 10, similarly to the example in FIG. 6, the central station may be a DU, and the distributed station may be an RU. In such a case, the transfer device 1b may be installed in a section called MFH, for example.

Also in the example in FIG. 10, similarly to the example in FIG. 6, the central station may be a Wi-Fi controller, and the distributed station may be a Wi-Fi access point.

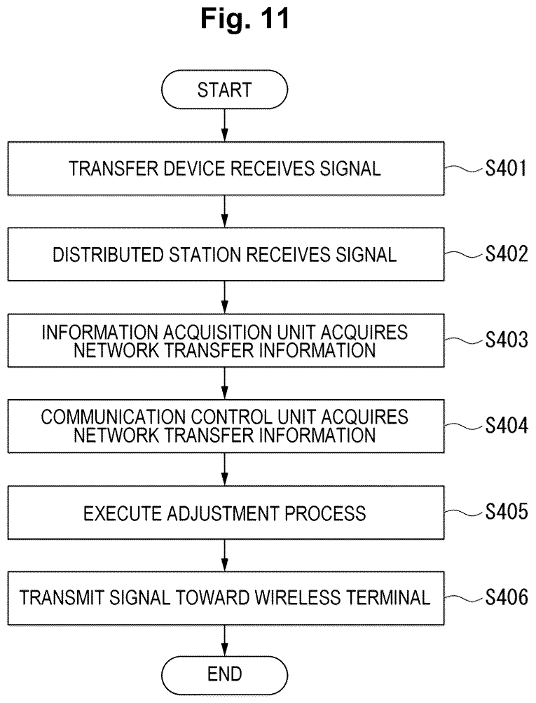

FIG. 11 is a flowchart illustrating an example of a flow of processing executed by the signal transfer system 100d according to the embodiment. More specifically, an example of a flow of processing executed by the signal transfer system 100d in a case where a signal is transmitted from the central station 903 to the wireless terminal 901 will be described. In the signal transfer system 100d, the processing illustrated in FIG. 11 is repeatedly performed.

The transfer device 1b receives a signal transmitted from the central station 903 (step S401). The signal acquired by the transfer device 1b in step S401 reaches the distributed station 4b via 0 or more transfer devices 1b. That is, the distributed station 4b receives the signal (step S402). The information acquisition unit 101 included in the distributed station 4b acquires network transfer information on the basis of the received signal (step S403). Next, the communication control unit 102 included in the distributed station 4b acquires the network transfer information acquired by the information acquisition unit 101 (step S404). The communication control unit 102 executes an adjustment process on the basis of the network transfer information (step S405). The communication control unit 102 transmits a signal in which a transmission timing or a transport block size is subjected to the adjustment process to the wireless terminal 901 (step S306).

In the example in FIG. 11, since the adjustment process is executed in step S405, an increase in jitter is curbed in the processing executed by the base station 3b in step S406.

The signal transfer system 100 configured as described above controls communication on the basis of the network transfer information. Therefore, an increase in jitter can be curbed.

### Example of Hardware Configuration of Each Device Provided in System

### Base Station

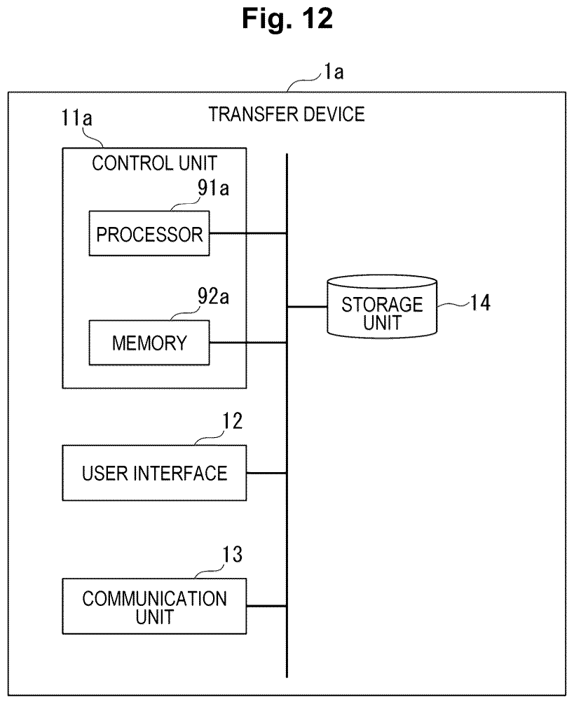

FIG. 12 is a diagram illustrating an example of a hardware configuration of the transfer device 1a (first transfer device) according to the embodiment. The transfer device 1a includes a control unit 11a including a processor 91a such as a central processing unit (CPU) and a memory 92a connected via a bus, and executes a program. The transfer device 1a functions as a device including the control unit 11a, a user interface 12, a communication unit 13, and a storage unit 14 by executing the program.

More specifically, in the transfer device 1a, the processor 91a reads the program stored in the storage unit 14, and stores the read program in the memory 92a. When the processor 91a executes the program stored in the memory 92a, the transfer device 1a functions as a device including the control unit 11a, the user interface 12, the communication unit 13, and the storage unit 14.

The control unit 11a controls operations of various functional units included in the transfer device 1a. The user interface 12 includes an input device such as a mouse, a keyboard, or a touch panel. The user interface 12 may include an interface that connects such an input device to the transfer device 1a.

The user interface 12 includes a display device such as a cathode ray tube (CRT) display, a liquid crystal display, or an organic electro-luminescence (EL) display. The user interface 12 may include an interface that connects such a display device to the transfer device 1a.

The communication unit 13 includes an interface that connects the transfer device 1a to an external device. The communication unit 13 communicates with an external device in a wired or wireless manner. The external device is, for example, a signal transmission source device. The communication unit 13 receives a signal through communication with a signal transmission source device. The external device is, for example, a signal transfer destination device. The communication unit 13 transfers a signal to a signal transfer destination through communication with a signal transfer destination device. The communication unit 13 transmits, for example, network transfer information to the information transfer unit 103.

The storage unit 14 is configured by using a computer-readable storage medium device such as a magnetic hard disk device or a semiconductor storage device. The storage unit 14 stores various types of information regarding the transfer device 1a. The storage unit 14 stores, for example, various types of information generated as a result of processing executed by the control unit 11a.

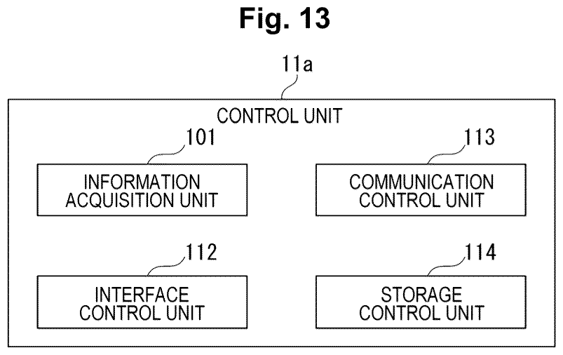

FIG. 13 is a diagram illustrating an example of a configuration of the control unit 11a included in the transfer device 1a according to the embodiment. The control unit 11a includes an information acquisition unit 101, an interface control unit 112, a communication control unit 113, and a storage control unit 114. The interface control unit 112 controls an operation of the user interface 12. The communication control unit 113 controls an operation of the communication unit 13. The storage control unit 114 controls an operation of the storage unit 14.

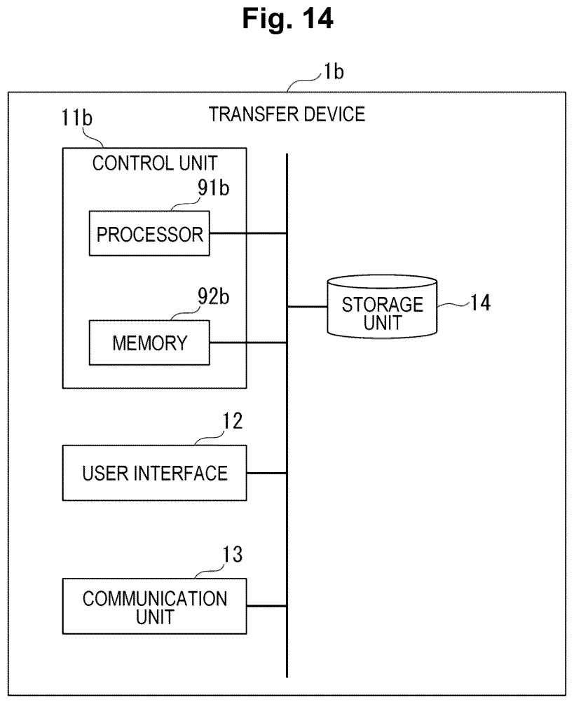

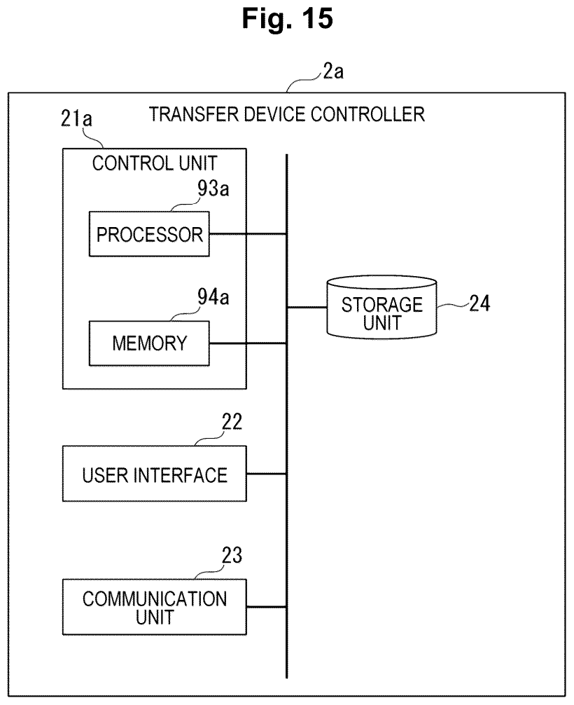

FIG. 14 is a diagram illustrating an example of a configuration of the transfer device 1b (second transfer device) according to the embodiment. Hereinafter, constituents having the same functions as those of the transfer device 1a are denoted by the same reference numerals as those in FIGS. 14 and 15, and description thereof will be omitted. The transfer device 1b is different from the transfer device 1a in including a control unit 11b instead of the control unit 11a.

The control unit 11b is different from the control unit 11a in including a processor 91b instead of the processor 91a and including a memory 92b instead of the memory 92a. The control unit 11b is different from the control unit 11a in not including that the information acquisition unit 101.

### Transfer Device Controller

FIG. 15 is a diagram illustrating an example of a hardware configuration of the transfer device controller 2a (first transfer device controller) according to the embodiment. The transfer device controller 2a includes a control unit 21a including a processor 93a such as a CPU and a memory 94a connected via a bus, and executes a program. The transfer device controller 2a functions as a device including the control unit 21a, a user interface 22, a communication unit 23, and a storage unit 24 by executing the program.

More specifically, in the transfer device controller 2a, the processor 93a reads the program stored in the storage unit 24, and stores the read program in the memory 94a. When the processor 93a executes the program stored in the memory 94a, the transfer device controller 2a functions as a device including the control unit 21a, the user interface 22, the communication unit 23, and the storage unit 24.

The control unit 21a controls operations of various functional units included in the transfer device controller 2a. The user interface 22 includes an input device such as a mouse, a keyboard, or a touch panel. The user interface 22 may include an interface that connects such an input device to the transfer device controller 2a.

The user interface 22 includes a display device such as a CRT display, a liquid crystal display, or an organic EL display. The user interface 22 may include an interface that connects such a display device to the transfer device controller 2a.

The communication unit 23 includes an interface that connects the transfer device controller 2a to an external device. The communication unit 23 communicates with an external device in a wired or wireless manner. The external device is, for example, the transfer device 1a or 1b. The external device is, for example, the base station 3a or the distributed station 4a. The communication unit 23 acquires, for example, network transfer information. The communication unit 23 transfers, for example, the network transfer information to a predetermined transfer destination such as the communication control unit 102.

The storage unit 24 is configured by using a computer-readable storage medium device such as a magnetic hard disk device or a semiconductor storage device. The storage unit 24 stores various types of information regarding the transfer device controller 2a. The storage unit 24 stores, for example, various types of information generated as a result of processing executed by the control unit 21a.

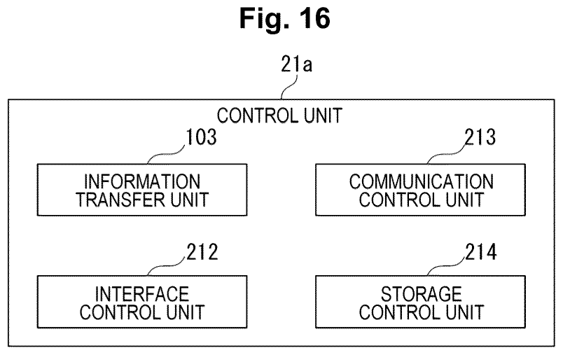

FIG. 16 is a diagram illustrating an example of a configuration of the control unit 21a included in the transfer device controller 2a according to the embodiment. The control unit 21a includes an information transfer unit 103, an interface control unit 212, a communication control unit 213, and a storage control unit 214. The interface control unit 212 controls an operation of the user interface 22. The communication control unit 213 controls an operation of the communication unit 23. The storage control unit 214 controls an operation of the storage unit 24.

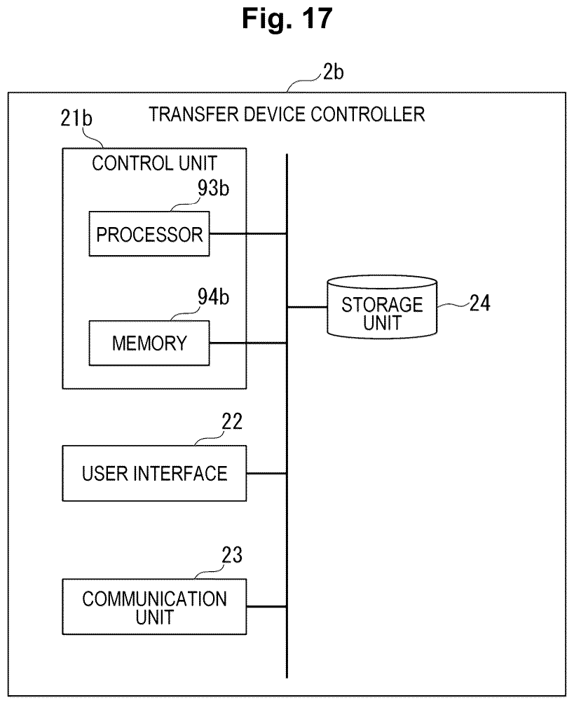

FIG. 17 is a diagram illustrating an example of a configuration of the transfer device controller 2b (second transfer device controller) according to the embodiment. Hereinafter, constituents having the same functions as those of the transfer device controller 2a are denoted by the same reference numerals as those in FIGS. 15 and 16, and description thereof will be omitted. The transfer device controller 2b is different from the transfer device controller 2a in including a control unit 21b instead of the control unit 21a.

The control unit 21b is different from the control unit 21a in including a processor 93b instead of the processor 93a and including a memory 94b instead of the memory 94a. The control unit 21b is different from the control unit 21a in not including the information transfer unit 103.

### Base Station

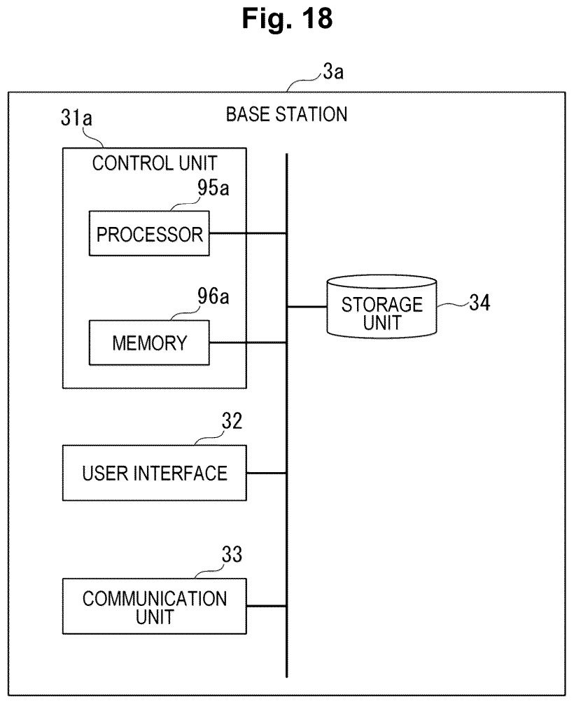

FIG. 18 is a diagram illustrating an example of a hardware configuration of the base station 3a (first base station) in the embodiment. The base station 3a includes a control unit 31a including a processor 95a such as a CPU and a memory 96a connected via a bus, and executes a program. The base station 3a functions as a device including the control unit 31a, a user interface 32, a communication unit 33, and a storage unit 34 by executing the program.

More specifically, in the base station 3a, the processor 95a reads the program stored in the storage unit 34, and stores the read program in the memory 96a. When the processor 95a executes the program stored in the memory 96a, the base station 3a functions as a device including the control unit 31a, the user interface 32, the communication unit 33, and the storage unit 34.

The control unit 31a controls operations of various functional units included in the base station 3a. The user interface 32 includes an input device such as a mouse, a keyboard, or a touch panel. The user interface 32 may include an interface that connects such an input device to the base station 3a.

The user interface 32 includes a display device such as a CRT display, a liquid crystal display, or an organic EL display. The user interface 32 may include an interface that connects such a display device to the base station 3a.

The communication unit 33 includes an interface that connects the base station 3a to an external device. The communication unit 33 communicates with an external device in a wired or wireless manner. The external device is, for example, the transfer device 1a. The external device is, for example, the wireless terminal 901. An operation of the communication unit 33 is controlled by the communication control unit 102. The communication unit 33 acquires the network transfer information through communication with, for example, the information transfer unit 103.

The storage unit 34 is configured by using a computer-readable storage medium device such as a magnetic hard disk device or a semiconductor storage device. The storage unit 34 stores various types of information regarding the base station 3a. The storage unit 34 stores, for example, various types of information generated as a result of processing executed by the control unit 31a.

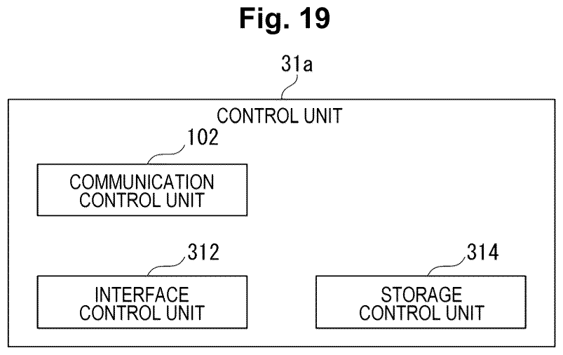

FIG. 19 is a diagram illustrating an example of a configuration of the control unit 31a included in the base station 3a according to the embodiment. The control unit 31a includes a communication control unit 102, an interface control unit 312, and a storage control unit 314. The interface control unit 312 controls an operation of the user interface 32. The storage control unit 314 controls an operation of the storage unit 24.

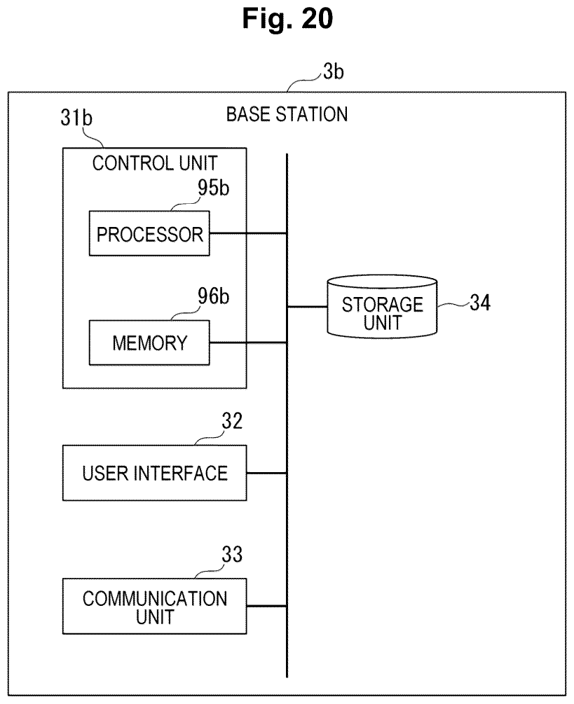

FIG. 20 is a diagram illustrating an example of a configuration of the base station 3b (second base station) according to the embodiment. Hereinafter, constituents having the same functions as those of the base station 3a are denoted by the same reference numerals as those in FIGS. 18 and 19, and description thereof will be omitted. The base station 3b is different from the base station 3a in including a control unit 31b instead of the control unit 31a. The control unit 31b is different from the control unit 31a in including a processor 95b instead of the processor 95a and including a memory 96b instead of the memory 96a.

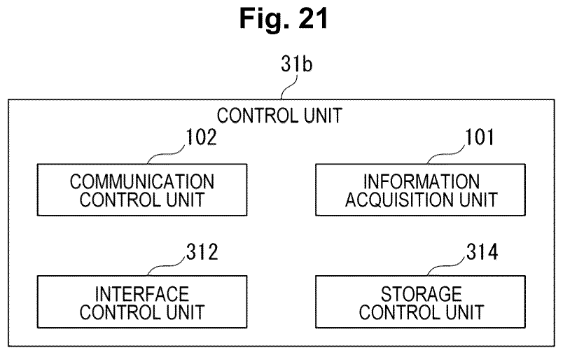

FIG. 21 is a diagram illustrating an example of a configuration of the control unit 31b included in the base station 3b according to the embodiment. The control unit 31b is different from the control unit 31a in further including an information acquisition unit 101.

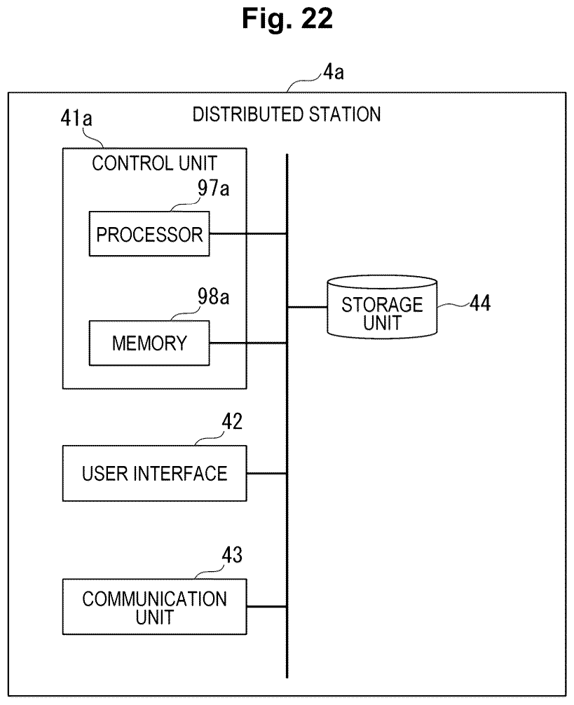

Distributed Station FIG. 22 is a diagram illustrating an example of a hardware configuration of the distributed station 4a (first distributed station) according to the embodiment. The distributed station 4a includes a control unit 41a including a processor 97a such as a CPU and a memory 98a connected via a bus, and executes a program. The distributed station 4a functions as a device including the control unit 41a, a user interface 42, a communication unit 43, and a storage unit 44 by executing a program.

More specifically, in the distributed station 4a, the processor 97a reads the program stored in the storage unit 44, and stores the read program in the memory 98a. When the processor 97a executes the program stored in the memory 98a, the distributed station 4a functions as a device including the control unit 41a, the user interface 42, the communication unit 43, and the storage unit 44.

The control unit 41a controls operations of various functional units included in the distributed station 4a. The user interface 42 includes an input device such as a mouse, a keyboard, or a touch panel. The user interface 42 may include an interface that connects such an input device to the distributed station 4a.

The user interface 42 includes a display device such as a CRT display, a liquid crystal display, or an organic EL display. The user interface 42 may include an interface that connects such a display device to the distributed station 4a.

The communication unit 43 includes an interface that connects the distributed station 4a to an external device. The communication unit 43 communicates with an external device in a wired or wireless manner. The external device is, for example, the transfer device 1a. The external device is, for example, the wireless terminal 901. An operation of the communication unit 43 is controlled by the communication control unit 102. The communication unit 43 acquires the network transfer information through communication with, for example, the information transfer unit 103.

The storage unit 44 is configured by using a computer-readable storage medium device such as a magnetic hard disk device or a semiconductor storage device. The storage unit 44 stores various types of information regarding the distributed station 4a. The storage unit 44 stores, for example, various types of information generated as a result of processing executed by the control unit 41a.

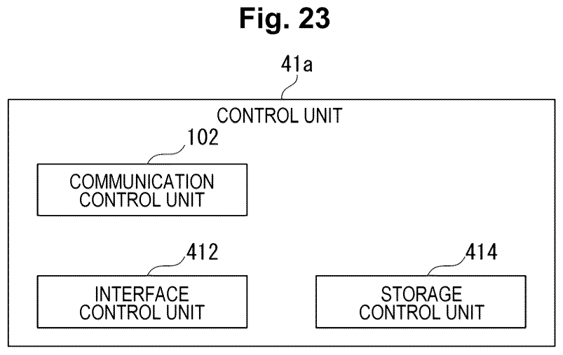

FIG. 23 is a diagram illustrating an example of a configuration of the control unit 41a included in the distributed station 4a according to the embodiment. The control unit 41a includes a communication control unit 102, an interface control unit 412, and a storage control unit 414. The interface control unit 412 controls an operation of the user interface 42. The storage control unit 414 controls an operation of the storage unit 44.

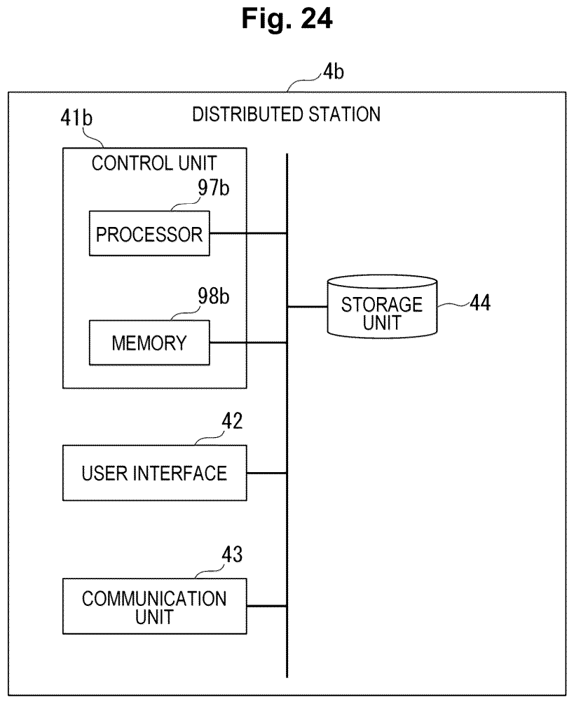

FIG. 24 is a diagram illustrating an example of a configuration of the distributed station 4b (second distributed station) according to the embodiment. Hereinafter, constituents having the same functions as those of the distributed station 4a are denoted by the same reference numerals as those in FIGS. 22 and 23, and description thereof will be omitted. The distributed station 4b is different from the distributed station 4a in including a control unit 41b instead of the control unit 41a. The control unit 41b is different from the control unit 41a in including a processor 97b instead of the processor 97a and including a memory 98b instead of the memory 98a.

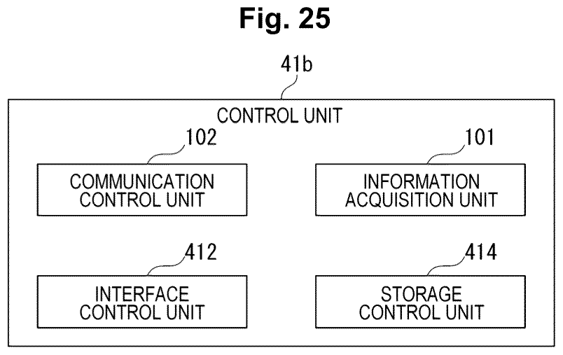

FIG. 25 is a diagram illustrating an example of a configuration of the control unit 41b included in the distributed station 4b according to the embodiment. The control unit 41b is different from the control unit 41a in further including an information acquisition unit 101.

### Communication Device Such as Server or Central Station

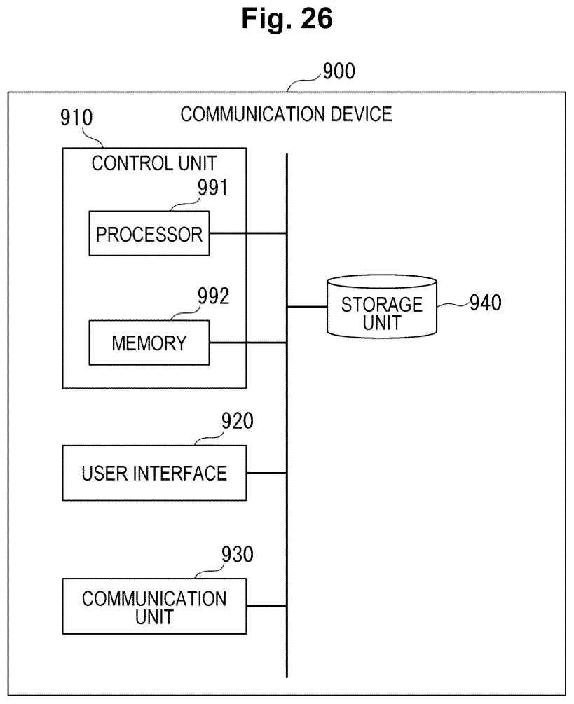

FIG. 26 is a diagram illustrating an example of a hardware configuration of the communication device 900 according to the embodiment. The communication device 900 includes a control unit 910 including a processor 991 such as a CPU and a memory 992 connected via a bus, and executes a program. The communication device 900 functions as a device including the control unit 910, a user interface 920, a communication unit 930, and a storage unit 940 by executing the program.

More specifically, in the communication device 900, the processor 991 reads the program stored in the storage unit 940, and stores the read program in the memory 992. When the processor 991 executes the program stored in the memory 992, the communication device 900 functions as a device including the control unit 910, the user interface 920, the communication unit 930, and the storage unit 940.

The control unit 910 controls operations of various functional units included in the communication device 900. The user interface 920 includes an input device such as a mouse, a keyboard, or a touch panel. The user interface 920 may include an interface that connects such an input device to the communication device 900.

The user interface 920 includes a display device such as a CRT display, a liquid crystal display, or an organic EL display. The user interface 920 may include an interface that connects such a display device to the communication device 900.

The communication unit 930 includes an interface that connects the communication device 900 to an external device. The communication unit 930 communicates with an external device in a wired or wireless manner. The external device is, for example, the transfer device 1a or the transfer device 1b.

The storage unit 940 is configured by using a computer-readable storage medium device such as a magnetic hard disk device or a semiconductor storage device. The storage unit 940 stores various types of information regarding the communication device 900. The storage unit 940 stores, for example, various types of information generated as a result of processing executed by the control unit 910.

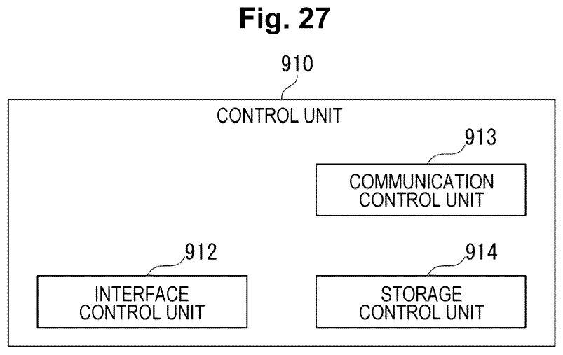

FIG. 27 is a diagram illustrating an example of a configuration of the control unit 910 included in the communication device 900 according to the embodiment. The communication device 900 includes an interface control unit 912, a communication control unit 913, and a storage control unit 914. The interface control unit 912 controls an operation of the user interface 920. The communication control unit 913 controls an operation of the communication unit 930. The storage control unit 914 controls an operation of the storage unit 940.

### Modification Examples

Note that the communication control unit 102 or the information transfer unit 103 may execute a process of analysis (hereinafter, referred to as an “analysis process”) based on network transfer information acquired from a plurality of information acquisition units 101. The analysis process includes, for example, a process of averaging values related to states of frames such as frame sizes and frame transmission intervals received from the plurality of information acquisition units 101.

The analysis process may include, for example, a process of predicting a state of a future frame such as a future frame size or a frame transmission interval on the basis of a value related to a state of a frame such as a frame size or a frame transmission interval received from the plurality of information acquisition units 101. A result of the analysis process is used for, for example, an adjustment process on future communication, and an effect in which a waiting time can be reduced even for a frame for which network transfer information has not been transferred to the communication control unit 102 is achieved.

Note that the signal transfer system 100a or 100c may further include a wireless controller 5. The wireless controller 5 controls operations of base stations such as the base station 3a and the base station 3b. Hereinafter, the signal transfer system 100 including the wireless controller 5 will be described by using the signal transfer system 100a as an example for simplicity of description. Hereinafter, the signal transfer system 100a including the wireless controller 5 will be referred to as a signal transfer system 100e.

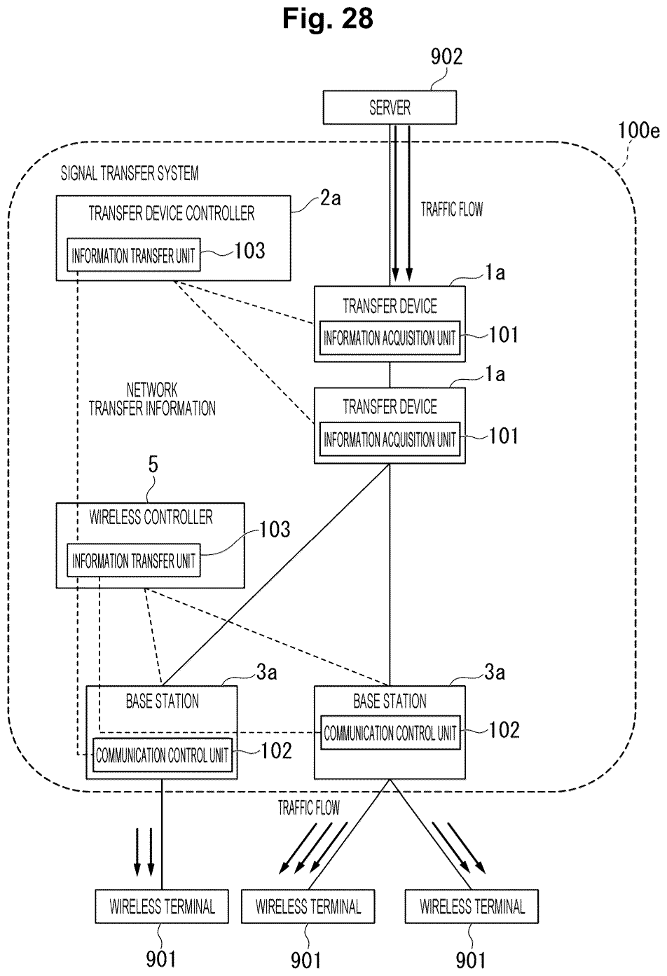

FIG. 28 is a diagram illustrating an example of a configuration of a signal transfer system 100e in a modification example. The signal transfer system 100e is different from the signal transfer system 100a in including the wireless controller 5. The wireless controller 5 controls an operation of the base station 3a. The wireless controller 5 includes an information transfer unit 103. The information transfer unit 103 included in the wireless controller 5 acquires the network transfer information transmitted by the information transfer unit 103 included in the transfer device controller 2a. The information transfer unit 103 included in the wireless controller 5 transfers the received network transfer information to the base station 3a.

As described above, the base station 3a may acquire the network transfer information not directly from the information transfer unit 103 included in the transfer device controller 2a but via the information transfer unit 103 included in the wireless controller 5.

### Example of Hardware Configuration of Wireless Controller

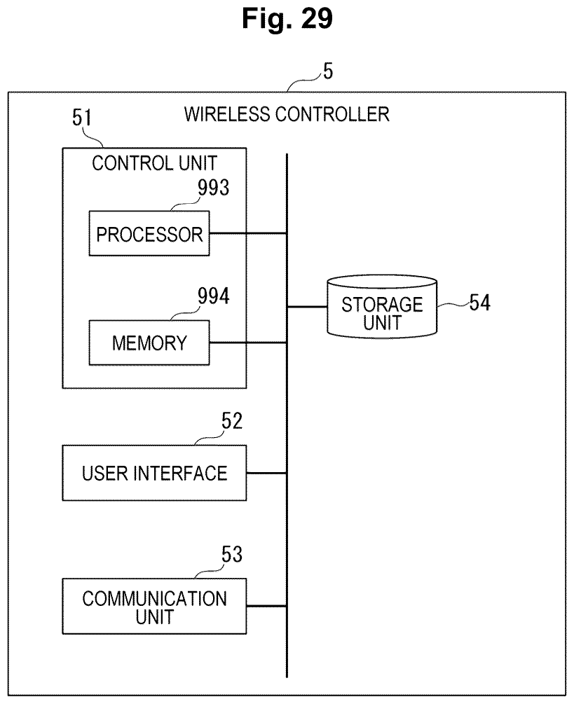

FIG. 29 is a diagram illustrating an example of a hardware configuration of the wireless controller 5 in the modification example. The wireless controller 5 includes a control unit 51 including a processor 993 such as a CPU and a memory 994 connected via a bus, and executes a program. The wireless controller 5 functions as a device including the control unit 51, a user interface 52, a communication unit 53, and a storage unit 54 by executing the program.

More specifically, in wireless controller 5, the processor 993 reads the program stored in the storage unit 54, and stores the read program in the memory 994. When the processor 993 executes the program stored in the memory 994, the wireless controller 5 functions as a device including the control unit 51, the user interface 52, the communication unit 53, and the storage unit 54.

The control unit 51 controls operations of various functional units included in the wireless controller 5. The user interface 52 includes an input device such as a mouse, a keyboard, or a touch panel. The user interface 52 may include an interface that connects such an input device to the wireless controller 5.

The user interface 52 includes a display device such as a CRT display, a liquid crystal display, or an organic EL display, for example. The user interface 52 may include an interface that connects such a display device to the wireless controller 5.

The communication unit 53 includes an interface that connects the wireless controller 5 to an external device. The communication unit 53 communicates with an external device in a wired or wireless manner. The external device is, for example, the transfer device controller 2a. The communication unit 53 acquires network transfer information through communication with the transfer device controller 2a. The external device is, for example, the base station 3a or the distributed station 4a. The communication unit 53 transmits network transfer information to, for example, the base station 3a or the distributed station 4a.

The storage unit 54 is configured by using a computer-readable storage medium device such as a magnetic hard disk device or a semiconductor storage device. The storage unit 54 stores various types of information regarding the wireless controller 5. The storage unit 54 stores, for example, various types of information generated as a result of processing executed by the control unit 51.

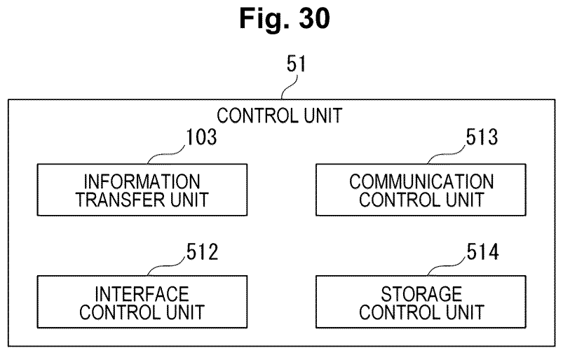

FIG. 30 is a diagram illustrating an example of a configuration of a control unit 51 included in the wireless controller 5 according to the modification example. The control unit 51 includes an information transfer unit 103, an interface control unit 512, a communication control unit 513, and a storage control unit 514. The interface control unit 512 controls an operation of the user interface 52. The communication control unit 513 controls an operation of the communication unit 53. The storage control unit 514 controls an operation of the storage unit 54.

Note that each of the devices included in each of the signal transfer systems 100 to 100e may be implemented by using a plurality of information processing devices communicatively connected via a network.

Note that all or some of the functions of each device included in the signal transfer systems 100 to 100e may be realized by using hardware such as an application specific integrated circuit (ASIC), a programmable logic device (PLD), or a field programmable gate array (FPGA). The program may be recorded on a computer-readable recording medium. The computer-readable recording medium is, for example, a portable medium such as a flexible disk, a magneto-optical disk, a ROM, or a CD-ROM, or a storage device such as a hard disk built in a computer system. The program may be transmitted via a telecommunication line.

Although the embodiment of this invention has been described in detail with reference to the drawings, specific configurations are not limited to this embodiment and include design and the like within the scope without departing from the concept of this invention.

### REFERENCE SIGNS LIST

100, 100a, 100b, 100c, 100d, 100e Signal transfer system
101 Information acquisition unit
102 Communication control unit
1a, 1b Transfer device
2a, 2b Transfer device controller
3a, 3b Base station
4a, 4b Distributed station
5 Wireless controller
11a, 11b, 21a, 21b, 31a, 31b, 41a, 41b, 51 Control unit
12, 22, 32, 42, 52 User interface
13, 23, 33, 43, 53 Communication unit
14, 24, 34, 44, 54 Storage unit
112, 212, 312, 412, 512 Interface control unit
113, 213, 513 Communication control unit
114, 214, 314, 414, 514 Storage control unit
900 Communication device
901 Wireless terminal
902 Server
903 Central station
910 Control unit
920 User interface
930 Communication unit
940 Storage unit
912 Interface control unit
913 Communication control unit
914 Storage control unit
91a, 91b, 93a, 93b, 95a, 95b, 97a, 97b, 991, 993 Processor
92a, 92b, 94a, 94b, 96a, 96b, 98a, 98b, 992, 994 Memory

1. A signal transfer system that transfers a signal from one communication device to another communication device, the signal transfer system comprising:
a first processor;
a first storage medium having computer program instructions stored thereon, wherein the computer program instruction, when executed by the first processor, perform processing of:
acquiring network transfer information that is information regarding a traffic flow for each traffic flow from the one communication device to the other communication device;
a second processor; and
a second storage medium having computer program instructions stored thereon, wherein the computer program instruction, when executed by the second processor, perform processing of:
executing an adjustment process that is a process of reducing a waiting time for a frame on the basis of the network transfer information.

2. The signal transfer system according to claim 1, wherein the adjustment process is one or both of a time division duplex (TDD) timing adjustment process of adjusting a frame transmission timing that is a timing at which a frame is transmitted in TDD according to a predetermined rule set in advance and a transport block size (TBS) adjustment process of adjusting a TBS according to a predetermined rule set in advance.

3. The signal transfer system according to claim 2, wherein
the other communication device is a wireless terminal, and
the frame transmission timing is a timing at which a downlink transmission frame that is a frame transmitted from the one communication device to the wireless terminal is transmitted.

4. The signal transfer system according to claim 1, wherein
the second storage medium stores computer program instructions which, when executed by the second processor, perform the processing of:
executing an analysis process based on the network transfer information.

5. The signal transfer system according to claim 1, further comprising:
a third processor;
a third storage medium having computer program instructions stored thereon, wherein the computer program instruction, when executed by the third processor, perform processing of:
transfering the network transfer information to the second processor, and
executing an analysis process based on the network transfer information.

6. The signal transfer system according to claim 4, wherein
the analysis process includes a process of averaging values related to a state of a frame.

7. The signal transfer system according to claim 4, wherein
the analysis process includes a process of predicting a state of a future frame on the basis of a value related to a state of a frame.

8. The signal transfer system according to claim 1, wherein
the information regarding the traffic flow indicates a downlink frame size and a transmission interval.

9. The signal transfer system according to claim 1, wherein
the information regarding the traffic flow indicates a transmission rate.

10. The signal transfer system according to claim 1, wherein
the information regarding the traffic flow indicates a destination address.

11. A signal transfer method of transferring a signal from one communication device to another communication device, the signal transfer method comprising:
acquiring network transfer information that is information regarding a traffic flow for each traffic flow from the one communication device to the other communication device; and
executing an adjustment process that is a process of reducing a waiting time for a frame on the basis of the network transfer information.
